(19) United States
(12) Patent Application Publication
(10) Pub. No.: US 2012/0192223 A1
(43) Pub. Date: Jul. 26, 2012

(54) SET-TOP BOX AND PROGRAM RECORDING METHOD

(75) Inventor: CHIEN-CHUNG KAO, Tu-Cheng (TW)

(73) Assignee: HON HAI PRECISION INDUSTRY CO., LTD., Tu-Cheng (TW)

(21) Appl. No.: 13/083,607

(22) Filed: Apr. 11, 2011

(30) Foreign Application Priority Data
Jan. 25, 2011 (CN) 201110027255.3

(51) Int. Cl. H04N 7/173; H04N 7/10

(52) U.S. Cl. 725/32; 725/134

(57) ABSTRACT

A set-top box receives media transport streams from a content provider server, decodes the media transport streams to a video program, and records the video program to a storage system. The video program includes program titles, program sections, and advertisements. The set-top box generates a plurality of unique identities of frames in one program title using types and media transport stream quantities of the frames. The set-top box signs other program titles in the video program by comparing types and media transport stream quantities of the frames with the generated unique identities during recording the video program. The set-top box can filter the advertisements according to the signed program titles.

### BACKGROUND

1. Technical Field

Embodiments of the present disclosure relate to set-top boxes, and more particularly to a program recording method of a set-top box.

2. Description of Related Art

A set-top box receives media transport streams from a content provider server and then decodes the media transport streams to video programs. The set-top box transmits the video programs to a television for playing and a user watches the video programs on the television. Sometimes, the user employs the set-top box to record the video programs in a storage system. Later, the user can watch the recorded programs whenever he or she wants, which is very convenient.

However, almost all video programs provided by the content provider include advertisements, and the user has to watch the advertisements when he or she watches the recorded programs. For example, one program lasting 45 minutes may be embedded with three advertisements each lasting 5 minutes. Therefore, the user needs to spend 1 hour on the program. Those advertisements disturb the user when the user watches the program and wastes a large percentage of time of the user. Most users would like to filter the advertisements when they watch the recorded programs.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of environment of a set-top box of one embodiment of the present disclosure;

FIG. 2 is a schematic diagram of functional modules of the set-top box of FIG. 1;

FIG. 3 illustrates a part of structure of a program recorded by the set-top box of FIG. 1 and FIG. 2;

FIG. 4 illustrates unique identities generated by the set-top box of FIG. 1 and FIG. 2;

FIG. 5 is a flowchart of a program recording method of one embodiment of the present disclosure;

FIG. 6 is a detail flowchart of block S502 generating the unique identities of the frames of FIG. 5; and

FIG. 7 is a flowchart of playing a recorded program of the se-top box of FIG. 1 and FIG. 2.

### DETAILED DESCRIPTION

All of the processes described may be embodied in, and fully automated over, software code modules executed by one or more general purpose computers or processors. The code modules may be stored in any type of computer-readable medium or other storage device. Some or all of the methods may alternatively be embodied in specialized computer hardware or communication apparatus.

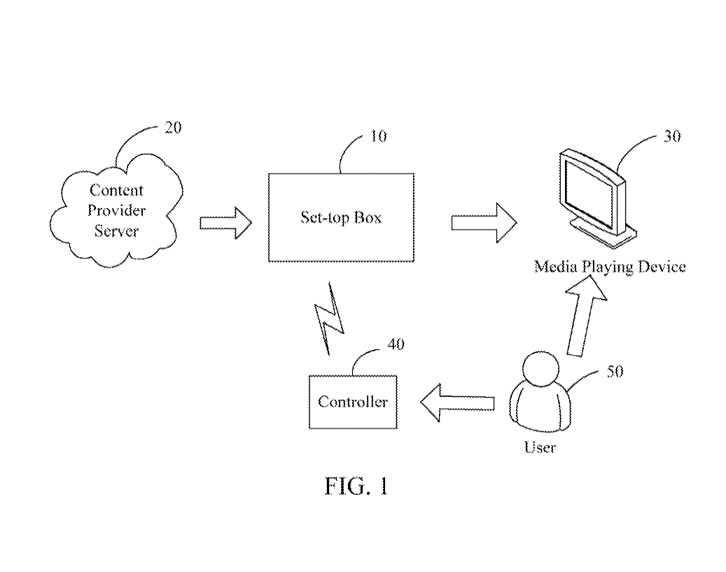

FIG. 1 is a schematic diagram of application environment of a set-top box 10 of one embodiment of the present disclosure. The set-top box 10 receives media transport streams from a content provider server 20 and decodes the media transport streams to video programs. Then, the set-top box 10 transmits the video programs to a media playing device 30, such as a television, for playing. A user 50 watches the video programs played by the media playing device 30, simultaneously uses a controller 40 to control the set-top box 10.

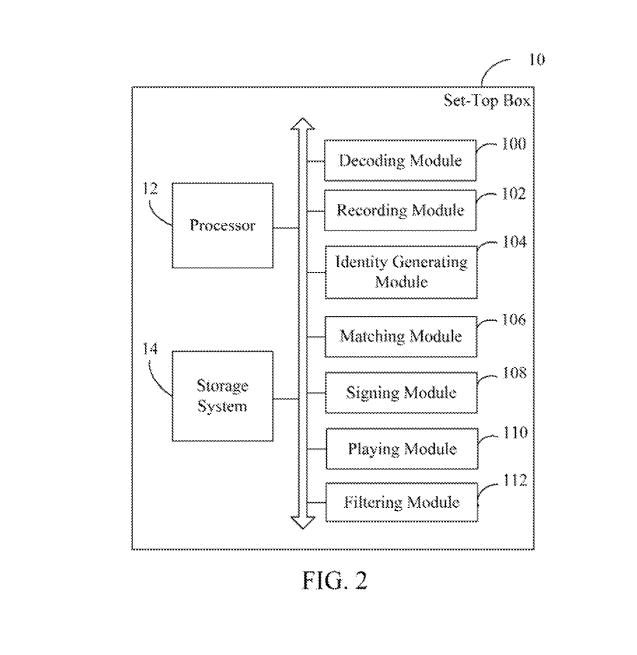

FIG. 2 is a schematic diagram of functional modules of a set-top box 10 of one embodiment of the present disclosure. In one embodiment, the set-top box 10 includes a processor 12, a storage system 14, a decoding module 100, a recording module 102, an identity generating module 104, a matching module 106, and a signing module 108. The set-top box 10 also controls the media playing device 30 to play the recorded video programs. The set-top box 10 further includes a playing module 110, and a filtering module 112.

The above modules 100-112 may comprise one or more software programs in the form of computerized codes that are stored in the storage system 14. The computerized codes include instructions that are executed by the processor 12 to provide functions for those modules 100-112. In one embodiment, the storage system 14 includes a synchronous dynamic random access memory (SDRAM), a hard disk, and other kinds of hardware in which data can be stored.

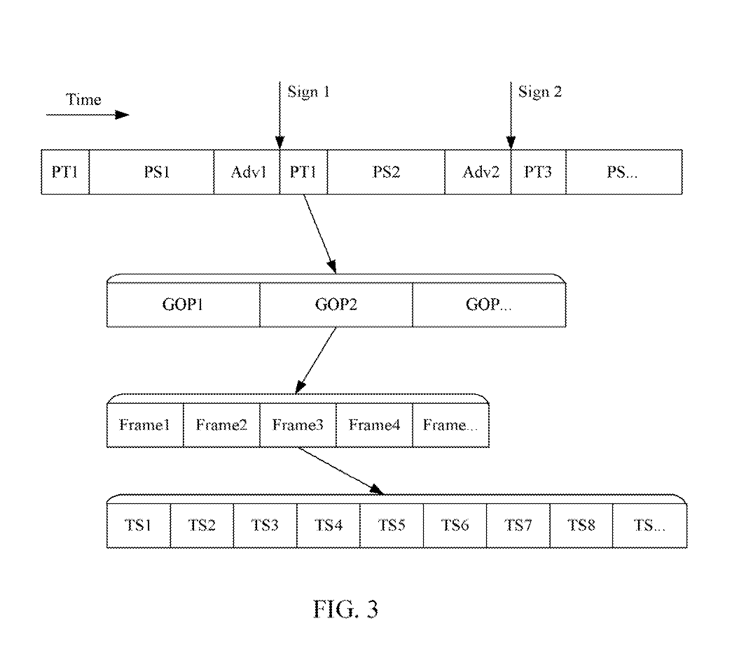

The decoding module 100 receives media transport streams from the content provider server 20 and decodes the media transport streams to video programs. The recording module 102 records the video programs to the storage system 14. Each of the video programs includes a series of frames. FIG. 3 illustrates a part of structure of the video programs recorded by the set-top box 10 of FIG. 1 of FIG. 2. In one embodiment, each of the video programs includes a plurality of program segments. Each program segment includes a program title (PT is used in FIG. 3 for simplicity), a program section (PS is used in FIG. 3 for simplicity), and an advertisement (Adv is used in FIG. 3 for simplicity). The program titles are duplicate contents which are used to remind the user 50 that the advertisement is completely played and the program section is coming.

In one embodiment, the decoding module 100 decodes the media transport streams according to the moving pictures experts group (MPEG) protocol. According to the MPEG protocol, each of the video programs can be divided into a plurality of group of pictures (GOP is used hereinafter and in FIG. 3, for simplicity). Then, one of the program titles, one of the program sections, or one of the advertisements respectively includes several GOPs. One GOP is a series of the decoded frames.

The MPEG protocol classes the frames into three types, namely intra frames (I-Frame), bidirectional frames (B-Frame), and predicted frames (P-Frame). In detail, the I-frame is a complete picture. The B-frame and the P-frame loads information of changing places of the picture comparing to the I-frame. The B-frame and the P-frame cannot be decoded without the I-frame. Each of the frames is decoded from several of the media transport streams (TS is used in FIG. 3 for simplicity).

The user 50 defines the program title when the set-top box 10 starts to record the video programs. In one embodiment, the user 50 can use the controller 40 of the set-top box 10 to define the program title. In detail, the user 50 presses a start key on the controller 40 when the user 50 watches the beginning of the program title in the media playing device 30, and the controller 40 transmits a start signal to the set-top box 10.

When watching the end of the program title in the media playing device 30, the user 50 presses an end key on the controller 40 and consequently the controller 40 transmits an ending signal to the set-top box 10. The set-top box 10 would know a time period between receiving the start signal and the ending signal during which the program title is played.

Referring to FIG. 2, the identity generating module 104 generates a unique identity of each of the frames belonging to the program title defined by the user 50. In one embodiment, the unique identity of one frame indicates type of the frame and a quantity of the media transport streams of the frame. In detail, the identity generating module 104 detects one I-frame in sequence from the decoded frames when detecting the starting signal. Subsequently, the identity generating module 104 starts to record the type and the quantity of media transport streams of each of the frames. Until detecting the ending signal, the identity generating module 104 stops recording the type and the quantity of media transport streams. Eventually, the identity generating module 104 combines the recorded type and the recorded quantity of media transport streams of each of the frames to generate the unique identities of the frames.

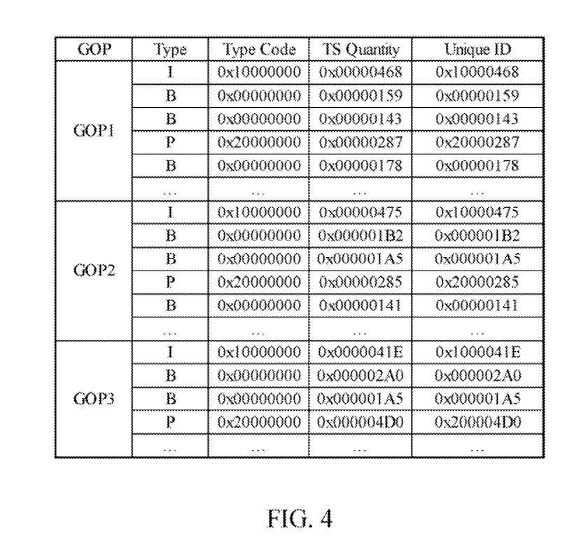

FIG. 4 illustrates unique identities generated by the set-top box 10 of FIG. 1 and FIG. 2. In one embodiment, the three types of the frames are respectively expressed as type code. To make space occupied by the type code smaller, the type code is preset as an 8-bit hexadecimal number. For example, the type code of the I-frame is preset as 0x10000000, the type code of the B-frame is preset as 0x00000000, and the type code of the P-frame is preset as 0x20000000.

The quantity of the media transport streams (TS quantity is used in FIG. 4 for simplicity) is also recorded as an 8-bit hexadecimal number. For example, if the quantity of the media transport streams of the I-frame of the first GOP is 1128, then the quantity of the media transport streams can be recorded as 0x00000468.

Then, the identity generating module 104 combines the type and the quantity of media transport streams using an OR operator to generate the unique identity (unique ID in FIG. 4 for simplicity). For example, the unique identity of the I-frame of the first GOP is 0x10000468 which is equal to an OR operator result of the type code of the I-frame 0x10000000 and the quantity of the media transport streams of the I-frame 0x00000468.

Referring to FIG. 2, during the recording module 102 recording the video program, the matching module 106 signs other program titles in the video program to filter the advertisements corresponding to the program titles.

In detail, the matching module 106 detects one of the I-frames from the decoded frames. To determine whether the detected I-frame matches the unique identity firstly generated by the identity generated module 106, the matching module 106 compares the quantity of the media transport streams of the detected I-frame with the unique identity firstly generated by the identity generated module 106. Here, that a frame matches a unique identity means the type and the quantity of the media transport streams of the frame are the same as what the unique identity indicates.

If the detected I-frame matches the unique identity firstly generated by the identity generated module 106, the detected I-frame may be the beginning of next program title.

Then, to determine whether latter frames of the detected I-frame match latter unique identities of the firstly generated unique identities or not, the matching module 106 compares the type and the quantity of media transport streams of the latter frames of the detected I-frame with the latter unique identities of the firstly generated unique identities one by one. In one embodiment, a quantity of the latter frames the matching module 106 should compare is equal to a quantity of the latter unique identities. Hereinafter are detail descriptions about the matching module 106 comparing the type and the quantity of media transport streams of the frames with the generated unique identities one by one.

Firstly, the matching module 106 detects one I-frame which matches the first unique identities 0x10000468. Secondly, the matching module 106 determines the type of a first frame after the detected I-frame, and records the quantity of the media transport streams of the first frame. Thirdly, the matching module 106 combines two 8-bit hexadecimal numbers respectively indicating the type and the quantity of media transport streams of the first frame with an OR operator to obtain a value corresponding to the first frame, and compares the value corresponding to the first frame with the second unique identity 0x00000159 which is generated by the identity generating module 104.

Then, the matching module 106 determines whether the value corresponding to the first frame is equal to the second unique identity 0x00000159 or not. If the value corresponding to the first frame is unequal to the second unique identity 0x00000159, the matching module 106 determines that the detected I-frame does not match the unique identity and the detected I-frame is not the beginning of the program title. Then, the matching module 106 continuously detects one next I-frame.

If the value corresponding to the first frame is equal to the second unique identity 0x00000159, the matching module 106 compares a value generated according to the type and the quantity of media transport streams of a second frame after the detected I-frame with the third unique identity 0x00000143. If the value of the second frame is equal to the third unique identity, then the matching module 106 compares a value of a third frame after the detected I-frame with the fourth unique identity 0x20000287. Until all the unique identities are compared to be respectively equal to the values of the corresponding frames, the matching module 106 determines that the latterly frames of the detected I-frame match the unique identities and the detected I-frame is the beginning of the program title.

If the detected I-frame is the beginning of the program title, the signing module 108 generates a sign corresponding to the detected I-frame. Then, the matching module 106 continuously detects next one of the I-frames and the signing module 108 continuously generates a next sign corresponding to the next one of the I-frames.

After obtaining several I-frames which are the beginning of several program titles, the signing module 108 obtains several signs. Each of the signs corresponds to one program segment, namely one program title, one program section, and one advertisement. If the sign is found, the beginning of the program title is accordingly obtained. Therefore, the set-top box 10 can jump over to next program titles according to the signs, which can filter the advertisements of the recorded video programs.

When the user 50 controls the set-top box 10 to play the recorded video program, the playing module 110 displays indications of the program segments of the recorded video programs according to the signs. In one embodiment, the indication of the program segment may be a picture, a video, a text, or any other links to the program segments.

The user 50 uses the controller 40 to select one of the program segments to play. Then, the playing module 110 controls the media playing device 30 to play the selected program segment according to one of the signs corresponding to the selected program segment. The media playing device 30 plays the program title, the program section, the advertisement in sequence. When the media playing device 30 plays the advertisement, the user 50 presses a key on the controller 40 to filter the advertisement and the controller 40 transmits a filtering signal to the set-top box 10.

Then, the filtering module 112 of the set-top box 10 receives the filtering signal, and then selects a next one of the signs corresponding to the current played program segment. The playing module 110 controls the media playing device 30 to play from the frame corresponding to the next one of the signs. Therefore, the media playing device 30 plays the next program segment and accordingly the advertisement is filtered.

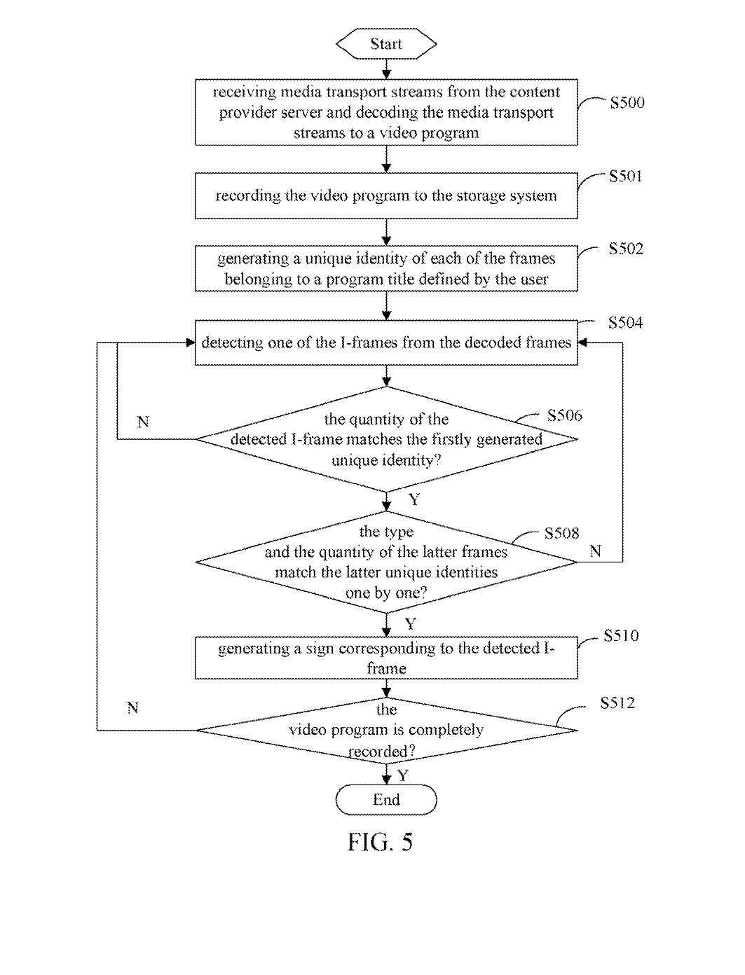

FIG. 5 is a flowchart of one embodiment of a program recording method of the present disclosure. The flowchart is executed by the modules of the set-top box 10 of FIG. 2. Depending on the embodiment, additional blocks may be added, others deleted, and the ordering of blocks may be changed while remaining well within the scope of the disclosure.

In block S500, the decoding module 100 receives media transport streams from the content provider server 20 and decodes the media transport streams to a video program. In one embodiment, the decoding module 100 decodes the media transport streams according to the MPEG protocol. In one embodiment, the video program includes several program segments. Each program segment includes a program title, a program section, and an advertisement. The program title, the program section, or the advertisement includes a plurality frames. In block S501, the recording module 102 records the video programs to the storage system 14. In block S502, the identity generating module 104 generates a unique identity of each of the frames belonging to a program title defined by the user 50. The unique identity of one frame indicates type of the frame and a quantity of the media transport streams of the frame.

In block S504, the matching module 106 detects one of the I-frames from the decoded frames. To determine whether the detected I-frame matches the unique identity firstly generated by the identity generated module 104 or not, in block S506, the matching module 106 compares the quantity of the media transport streams of the detected I-frame with the firstly generated unique identity. Here, that a frame matches a unique identity means the type and the quantity of the media transport streams of the frame are the same as what the unique identity indicates.

If the detected I-frame does not match the firstly generated unique identity, the detected I-frame is not the beginning of the next program title. Then in block S504, the matching module 106 detects next one of the I-frames from the decoded frames.

If the detected I-frame matches the firstly generated unique identity, the detected I-frame may be the beginning of next program title. Then, to determine whether latter frames of the detected I-frame match the latter unique identities of the firstly generated unique identity or not, in block S508, the matching module 106 compares the type and the quantity of media transport streams of the latter frames of the detected I-frame with the latter unique identities of the firstly generated unique identity one by one.

If the latter frames of the detected I-frame do not match the latter unique identities of the firstly generated unique identity one by one, then in block S504, the matching module 106 detects next one of the I-frames from the decoded frames.

If the latter frames of the detected I-frame match the latter unique identities of the firstly generated unique identity one by one, the detected I-frame is the beginning of the program title, and in block S510, the signing module 108 generates a sign corresponding to the detected I-frame. Then continuously from block S504 to block S510, the matching module 106 detects next one of the I-frames from the decoded frames and the signing module 108 generates next sign corresponding to the next one I-frame until in block S512 the video program recording is complete.

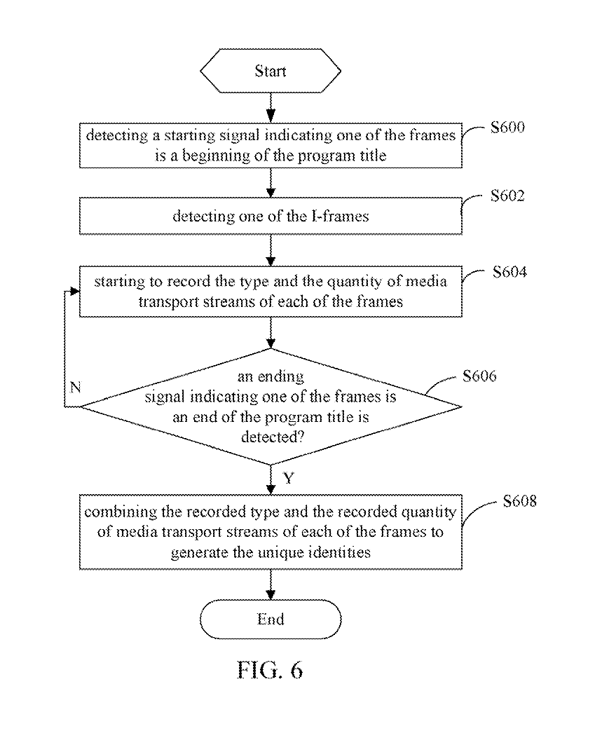

FIG. 6 is a flowchart of one embodiment of block S502 generating the unique identity of each of the frames belonging to the program title defined by the user 50 of FIG. 5. The flowchart is executed by the modules of the set-top box 10 of FIG. 2. Depending on the embodiment, additional blocks may be added, others deleted, and the ordering of blocks may be changed while remaining well within the scope of the disclosure.

In block S600, the identity generating module 104 detects a starting signal indicating one of the frames is a beginning of the program title. In block S602, the identity generating module 104 detects one of the I-frames. In block S604, the identity generating module 104 starts to record the type and the quantity of media transport streams of each of the frames until in block S606 an ending signal indicating one of the frames is an end of the program title is detected.

If the ending signal is detected, then in block S608, the identity generating module 104 combines the recorded type and the recorded quantity of media transport streams of each of the frames to generate the unique identities corresponding to the frames. In one embodiment, the type and the quantity of media transport streams are respectively recorded as an 8-bit hexadecimal number, and the type and the quantity of media transport streams are combined using an OR operator.

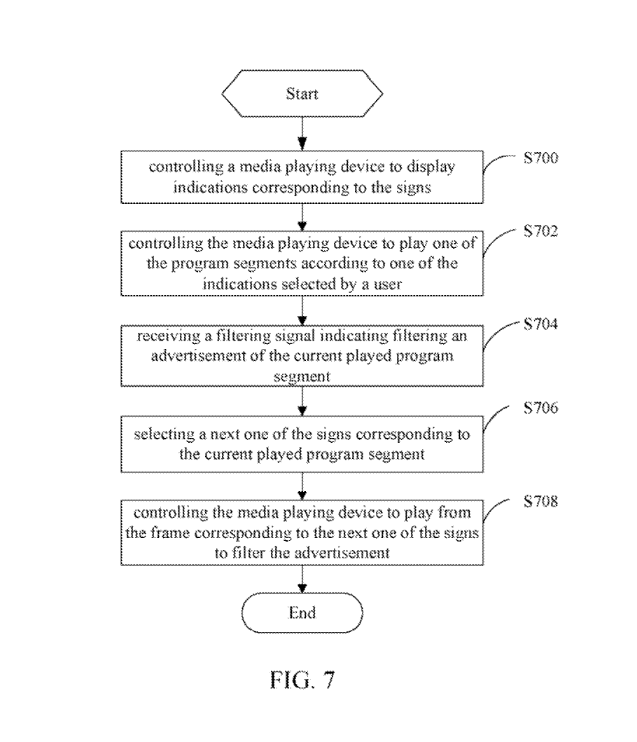

FIG. 7 is a flowchart of playing a recorded video program of the set-top box 10 of FIG. 1 and FIG. 2. The flowchart is executed by the modules of the set-top box 10 of FIG. 2. Depending on the embodiment, additional blocks may be added, others deleted, and the ordering of blocks may be changed while remaining well within the scope of the disclosure.

When the user 50 controls the set-top box 10 to play the recorded video program, in block S700, the playing module 110 displays indications of the signs. The indications show the program segments the set-top box 10 recorded to the user 50. In one embodiment, the indication of the one of the signs may be a picture, a video, a text, or any other links to the corresponding program segments.

The user 50 uses the controller 40 to select one of the indications to play. Then, in block S702, the playing module 110 controls the media playing device 30 to play one of the program segments according to one of the signs corresponding to the selected indication. The media playing device 30 plays the program title, the program section, the advertisement in sequence. When the media playing device 30 plays the advertisement, the user 50 presses a key on the controller 40 to filter the advertisement and the controller 40 transmits a filtering signal to the set-top box 10.

Then, in block S704, the filtering module 112 of the set-top box 10 receives the filtering signal, and then, in block S706, selects a next one of the signs corresponding to the current played program segment. In block S708, the playing module 110 controls the media playing device 30 to play from the frame corresponding to the next one of the signs. Therefore, the media playing device 30 plays the next program segment and accordingly the advertisement is filtered.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A set-top box, comprising:
a processor; and
a storage system storing one or more software programs in the form of computerized codes operable to be executed by the processor, the one or more software programs comprising:
a decoding module for receiving media transport streams from a content provider server and decoding the media transport streams to a video program comprising several types of frames comprising intra frames, bidirectional frames, and predicted frames, wherein one of the frames is decoded from a plurality of the media transport streams;
a recording module for recording the video program to the storage system;
an identity generating module for generating an unique identity of each of the frames belonging to a program title wherein the unique identity of one frame indicating type of the frame and a quantity of the media transport streams of the frame;
a matching module for detecting one of the intra frames from the decoded frames and comparing the quantity of the media transport streams of the detected intra frame with the unique identity firstly generated by the identity generating module to determine whether the detected intra frame matches the firstly generated unique identity, and for comparing the type and the quantity of media transport streams of latter frames of the detected intra frame with latter unique identities of the firstly generated unique identity one by one to determine whether the latter frames match the latter unique identities upon the condition that the detected intra frame matches the firstly generated unique identity; and
a signing module for generating a sign corresponding to the detected intra frame upon the condition that the latter frames match the latter unique identities;
wherein the matching module continuously detects a next one of the intra frames and the signing module continuously generates next sign corresponding to the next one of the intra frames until the video program is completely recorded.

2. The set-top box as claimed in claim 1, wherein the matching module detects the next one of the intra frames upon the condition that any one of the frames does not match the corresponding unique identity.

3. The set-top box as claimed in claim 1, wherein the identity generating module detects a starting signal indicating one of the frames is a beginning of the program title.

4. The set-top box as claimed in claim 3, wherein the identity generating module detects one of the intra frames if the starting signal is detected.

5. The set-top box as claimed in claim 4, wherein the identity generating module starts to record the type and the quantity of media transport streams of each of the frames if the one intra frame is detected until detects an ending signal indicating one of the frames is an end of the program title.

6. The set-top box as claimed in claim 5, wherein the starting signal and the ending signal are input by a controller of the set-top box.

7. The set-top box as claimed in claim 5, wherein the identity generating module combines the recorded type and the recorded quantity of media transport streams of each of the frames to generate the unique identities of the frames.

8. The set-top box as claimed in claim 7, wherein the identity generating module records the type and the quantity of media transport streams respectively as an 8-bit hexadecimal number.

9. The set-top box as claimed in claim 8, wherein the identity generating module uses an OR operator to combine the type and the quantity of media transport streams.

10. The set-top box as claimed in claim 1, further comprising:
a playing module for controlling a media playing device to display indications corresponding to the signs, and controlling a media playing device to play one of the program segments according to one of the indications selected by a user.

11. The set-top box as claimed in claim 10, further comprising:
a filtering module for receiving a filtering signal indicating filtering an advertisement of the current played program segment, and selecting a next one of the signs corresponding to the current played program segment;
wherein the playing module controls the media playing device to play from the frame corresponding to the next one of the signs to filter the advertisement.

12. A program recording method of a set-top box, comprising:
receiving media transport streams from a content provider server and decoding the media transport streams to a video program comprising several types of frames comprising intra frames, bidirectional frames, and predicted frames, wherein one of the frames is decoded from a plurality of the media transport streams;
recording the video program to the storage system;
generating an unique identity of each of the frames belonging to a program title, wherein the unique identity of one frame indicating type of the frame and a quantity of the media transport streams of the frame; and
signing other program titles until the video program is completely recorded, wherein signing one of the other program titles comprises:
detecting one of the intra frames from the decoded frames;
comparing the quantity of the media transport streams of the detected intra frame with the unique identity firstly generated by the identity generating module to determine whether the detected intra frame matches the firstly generated unique identity or not;
comparing the type and the quantity of media transport streams of latter frames of the detected intra frame with latter unique identities of the firstly generated unique identity one by one to determine whether the latter frames match the latter unique identities if the detected intra frame matches the firstly generated unique identity; and
generating a sign of one of the other program titles corresponding to the detected intra frame if the latter frames match the latter unique identities.

13. The program recording method as claimed in claim 12, further comprising:
detecting a next one of the intra frames if any one of the frames does not match the corresponding unique identity.

14. The program recording method as claimed in claim 12, wherein generating an unique identity comprising:
detecting a starting signal indicating one of the frames is a beginning of the program title;
detecting one of the intra frames;
starting to record the type and the quantity of media transport streams of each of the frames until detecting an ending signal indicating one of the frames is an end of the program title; and
combining the recorded type and the recorded quantity of media transport streams of each of the frames to generate the unique identities of the frames.

15. The program recording method as claimed in claim 14, wherein the starting signal and the ending signal are input by a controller of the set-top box.

16. The program recording method as claimed in claim 14, wherein the type and the quantity of media transport streams are respectively recorded as an 8-bit hexadecimal number.

17. The program recording method as claimed in claim 16, wherein the type and the quantity of media transport streams are combined by using an OR operator.

18. The program recording method as claimed in claim 12, further comprising:
controlling a media playing device to display indications corresponding to the signs; and
controlling the media playing device to play one of the program segments according to one of the indications selected by a user.

19. The program recording method as claimed in claim 18, further comprising:
receiving a filtering signal indicating filtering an advertisement of the current played program segment;
selecting a next one of the signs corresponding to the current played program segment; and
controlling the media playing device to play from the frame corresponding to the next one of the signs to filter the advertisement.
